(19) United States
(12) Patent Application Publication
(10) Pub. No.: US 2001/0008429 A1
(43) Pub. Date: Jul. 19, 2001

(54) Gamma correction circuit for imaging signal and display apparatus including such gamma correction circuit

(75) Inventor: Akira Arimizu, Kagoshima (JP)

Correspondence Address: Ronald P. Kananen, Esq., RADER, FISHMAN & GRAUER, The Lion Building, 1233 20th Street, N.W., Suite 501, Washington, DC, 20036, US

(73) Assignee: Sony Corporation

(21) Appl. No.: 09/760,826

(22) Filed: Jan. 17, 2001

(30) Foreign Application Priority Data
Jan. 19, 2000 (JP) P2000-010560

(51) Int. Cl. H04N 5/202; H04N 9/69

(52) U.S. Cl. 348/674; 348/675

(57) ABSTRACT

A gamma correction circuit includes a main imaging signal processing circuit and a correction signal generating circuit. The main imaging signal processing circuit receives an input imaging signal (RGB signals: 3 three primary color signals) Si, and generates an output imaging signal on the basis of a predetermined reference voltage and an output resistance. Moreover, the correction signal generating circuit includes a plurality of current differential amplifiers connected in parallel with each other, and is configured so that the input imaging signal is supplied to the current differential amplifiers and each output of the current differential amplifiers is added to the generated output imaging signal from the main imaging signal processing circuit. A gamma corrected imaging signal So produced by adding the gamma correction signal and the output imaging signal from the main imaging signal processing circuit is supplied to, for example a signal amplifying circuit (pre-amplifier in an embodiment) of a computer display apparatus.

### BACKGROUND OF THE INVENTION

1. Field of the Invention

The present invention relates to a gamma correction circuit for correcting the luminous characteristic of a cathode ray tube and a display apparatus including such gamma correction circuit. Further this invention relates particularly to a gamma correction circuit for performing gamma correction for a imaging signal of a computer display apparatus and the like that is required to have a high resolution, and a display apparatus including such gamma correction circuit.

2. Description of the Related Art

A gamma correction circuit is used for correcting a luminous characteristic of a cathode ray tube so as to perform a linear variation in its brightness in accordance with supplied voltages. From a consideration of the imaging signal frequency, the gamma correction circuit has not been used in a computer display apparatus handling high frequency signal, although the gamma correction circuit has been conventionally installed in a TV set.

However, in recent years, opportunities to display video images or another full color images on a computer display apparatus have been increased. In addition, color printers become popular, and consequently it becomes important for the computer display apparatus to match its color tone with that of the color printer. In such a situation, it is highly demanded to display video images or other images on the computer display apparatus more clearly. Consequently, it becomes more popular to use the gamma correction circuit in the computer display apparatus.

That is, an imaging signal (R, G and B color signals) is supplied to a cathode ray tube of the computer display apparatus through an imaging signal amplifying circuit, and a gamma correction circuit is provided at a preceding stage of the imaging signal amplifying circuit. Thereby, the gamma correction is performed for the imaging signal to be supplied to the computer display apparatus.

A conventional gamma correction circuit has such configuration that a plurality of differential amplifiers for generating a gamma correction signal are connected in parallel with a differential amplifier of a main signal processing circuit for processing a main imaging signal. The respective differential amplifiers for generating the gamma correction signal have different gain characteristics, and the respective outputs of these differential amplifiers are commonly led to an output resistance of the differential amplifier of the main signal processing circuit. That is, the output resistance of the differential amplifier of the main signal processing circuit is commonly used as an output resistance of the differential amplifiers for generating the gamma correction signal.

Generally two methods are known for changing a correction amount of the gamma correction signal for the gamma correction. One of them is to change resistance value of a resistive element for adjusting an amplification factor of each differential amplifier for generating the gamma correction signal. The other method is to change resistance value of the output resistance of the main signal processing circuit.

However, these two methods change output signal level of the main imaging signal, too. Moreover, there occur disadvantages that the dynamic ranges of inputs of the differential amplifiers for generating the gamma correction signal are changed and then a correction point (inflection point) is changed, and so forth. Namely these methods cannot control exactly the level of the gamma correction signal due to the above mentioned situation.

As described above, whenever the correction amount of the gamma correction is adjusted, the adjustment cannot but influence a correction point and a frequency characteristic according to the conventional method. That is, it has been impossible to control the gamma correction amount.

### SUMMARY OF THE INVENTION

The present invention was made in consideration of the aforesaid circumstances, and an object of the present invention is to provide a gamma correction circuit enabling the control of the gamma correction amount without affecting a correction point and a frequency characteristic, and to provide a display apparatus including such gamma correction circuit.

According to a first aspect of the present invention, there is provided a gamma correction circuit for correcting a luminous characteristic of a cathode ray tube. The gamma correction circuit comprises a main signal processing circuit for generating a imaging signal in accordance with an input imaging signal on a basis of a first predetermined reference voltage and an output resistance, and a correction signal generating circuit for generating a gamma correction signal to be added to the imaging signal from the main signal processing circuit in response to the input imaging signal supplied to the correction signal generating circuit, wherein the correction signal generating circuit includes a plurality of current differential amplifiers connected in parallel to each other.

According to the first aspect of the present invention, because the correction signal generating circuit is composed of a plurality of current differential amplifiers, the correction amount of the gamma correction signal can be adjusted by changing a current ratio concerning the operation of each of the current differential amplifiers. Consequently, there can be provided a gamma correction circuit in which a gamma correction amount can be controlled without changing a ratio concerning the output resistance that affects a correction point and a frequency characteristic.

According to a second aspect of the present invention, there is provided a display apparatus comprises a gamma correction circuit to which an input imaging signal is supplied; an amplifier for amplifying a gamma corrected output imaging signal from the gamma correction circuit, and an electron gun to which an output signal from the amplifier is supplied. In this apparatus the gamma correction circuit comprises: a main signal processing circuit for generating a imaging signal in accordance with the input imaging signal on a basis of a first predetermined reference voltage and an output resistance, and a correction signal generating circuit for generating a gamma correction signal to be added to the imaging signal from the main signal processing circuit in response to the input imaging signal supplied to the correction signal generating circuit, wherein the correction signal generating circuit includes a plurality of current differential amplifiers connected in parallel to each other.

According to the second aspect of the invention, because the display apparatus includes a gamma correction circuit correction signal that in turn includes a correction signal generating circuit composed of a plurality of current differential amplifiers, the correction amount of the gamma correction signal can be adjusted by changing a current ratio concerning the operation of each of the current differential amplifiers. Consequently, there can be provided a display apparatus in which a gamma correction amount can be controlled without changing a ratio concerning the output resistance of the main imaging signal processing circuit that affects a correction point and a frequency characteristic.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a circuit block diagram showing the configuration of a gamma correction circuit according to an embodiment of the present invention;

FIG. 2 is a circuit block diagram showing an example of a computer display apparatus to which the gamma correction circuit shown in FIG. 1 is applied;

FIG. 3 is a circuit diagram showing the configuration of a gamma correction circuit capable of being used in the configurations shown in FIGS. 1 and 2; and

FIG. 4 is a circuit diagram showing an example of individual correction signal generating circuit (13, 14 or 15) shown in FIG. 3.

### DESCRIPTION OF THE PREFERRED EMBODIMENTS

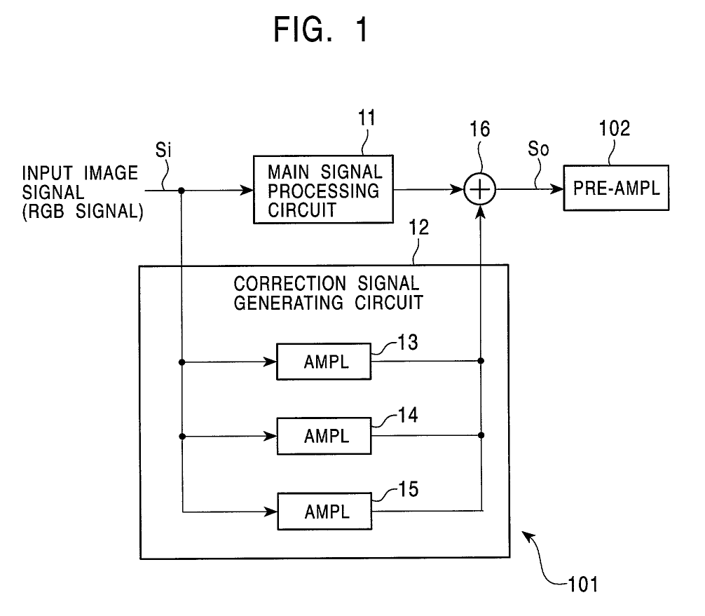

FIG. 1 is a circuit block diagram showing a configuration of a gamma correction circuit according to an embodiment of the present invention. A gamma correction circuit 101 includes a main signal processing circuit 11 and a correction signal generating circuit 12. The main signal processing circuit 11 receives an input imaging signal (RGB signals: three primary color signals) Si, and generates an output signal on a basis of a predetermined voltage and an output resistance. The main signal processing circuit 11 has the output resistance, but not shown in this figure. Moreover, the correction signal generating circuit 12 includes a plurality of current differential amplifiers 13, 14 and 15 connected in parallel with each other. The correction signal generating circuit 12 is configured so that the input imaging signal Si is supplied and respective output is added to the imaging signal from the main signal processing circuit 11 at an adder circuit 16. An output imaging signal So generated by adding the gamma correction signal to the imaging signal generated by the main signal processing circuit 11 is supplied to, for example, a pre-amplifier 17 in the embodiment of a computer display apparatus.

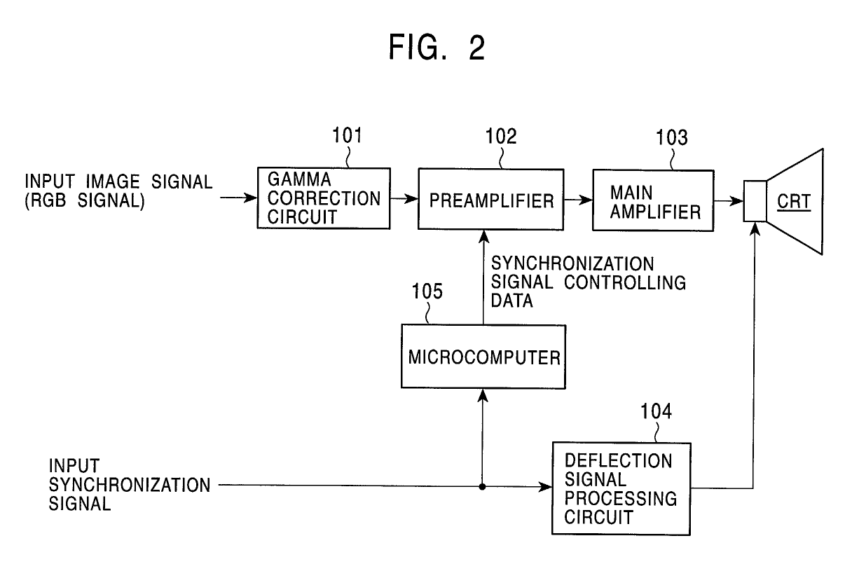

FIG. 2 is a circuit block diagram showing an example of a computer display apparatus to which the gamma correction circuit 101 shown in FIG. 1 is applied. A display device CRT in the computer display apparatus comprises an electron gun equipped with cathodes of respective colors R(red), G(green) and B(blue), deflection yokes for deflecting electron beams emitted by the cathodes in the horizontal direction and the vertical direction, and so forth, although all of them are not shown. The display device CRT displays an image by irradiating its fluorescent screen, not shown, with electron beams generated on the basis of the output imaging signals from a imaging signal processing circuit and a deflection signal processing circuit.

In the imaging signal processing circuit, a pre-amplifier 102 and a main imaging amplifier 103 perform a contrast control (control of light and shade of white and black) and a brightness control (control of brightness of an imaging signal) of the imaging signal.

In the deflection signal processing circuit, an input synchronization signal includes a horizontal synchronization signal and a vertical synchronization signal. On these synchronization signals, a deflection signal processing circuit 104 functions to control the generation of magnetic fields by the deflection yokes of the display device CRT. Thereby, the electron beams emitted by the electron gun are deflected in the horizontal direction and the vertical direction. A microcomputer 105 supplies a control data to the pre-amplifier 102 in accordance with the synchronization signal.

The gamma correction circuit 101 of the present invention is provided at the preceding stage of the preamplifier 102 in the imaging signal processing circuit, and performs the gamma correction processing of the imaging signal. That is, the imaging signal from the gamma correction circuit 101 is amplified by the pre-amplifier 102, and further is amplified by a main imaging amplifier 103. Although not shown, the gamma correction circuit 101, the pre-amplifier 102 and the main amplifier 103 are provided to each of the color signals of Red, Green and Blue, respectively. incidentally, although not shown, the gamma correction circuit 101 may be provided in the pre-amplifier 102.

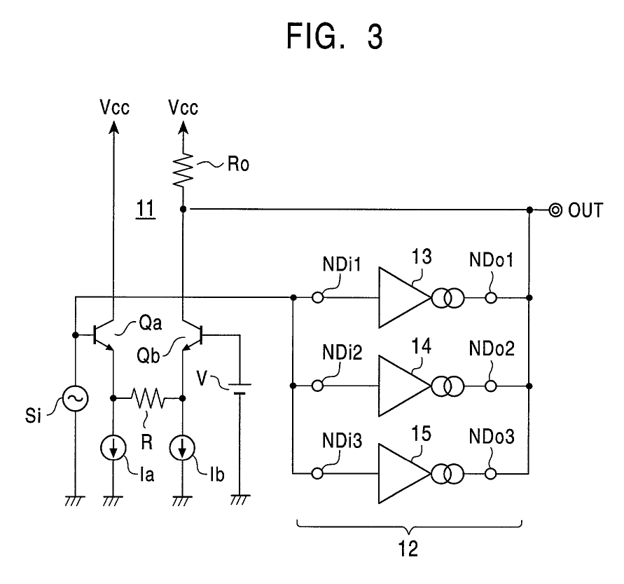

FIG. 3 is a circuit diagram showing the configuration of the gamma correction circuit 101 used in the configurations shown in FIGS. 1 and 2. The main signal processing circuit 11 is configured as a differential amplifier including transistors Qa and Qb, a resistive element R, constant current sources Ia and Ib and an output resistor Ro.

In FIG. 3, an emitter electrode of the transistor Qa and an emitter electrode of the transistor Qb are connected with each other through the resistive element R. The emitter electrode of the transistor Qa is grounded through the constant current source Ia. An emitter electrode of the transistor Qb is grounded through the constant current source Ib (the same one as the constant current source Ia). The input imaging signal Si (one of the R, G and B signals) is supplied to the base electrode of the transistor Qa. The base electrode of the transistor Qb is connected with a constant-voltage power supply V that generates a reference voltage V for a differential amplifier of the main signal processing circuit 11. A collector electrode of the transistor Qa is connected with a power source voltage Vcc. A collector electrode of the transistor Qb is connected with the power source voltage Vcc through the output resistor Ro.

Furthermore, the correction signal generating circuit 12 is configured by the current differential amplifiers 13, 14 and 15 connected in parallel with each other, as described above. The same input imaging signal Si as the imaging signal supplied to the main imaging signal processing circuit 11 is supplied to input nodes NDi1 to NDi3 of the current differential amplifiers 13, 14 and 15. Output nodes NDo1 to NDo3 of these current differential amplifiers 13, 14 and 15 are connected with an output terminal OUT, respectively. The output terminal OUT is common to the output terminal of the main imaging signal processing circuit 11, and is connected with a connection point of one end of the output resistor Ro and the transistor Qb. That is, an output imaging signal So, which is a mixture of the main imaging signal and the gamma correction signal, is obtained from the output terminal OUT.

Using aforesaid configuration, the correction amount of the gamma correction signal can be controlled by altering a current ratio of each of the current differential amplifiers 13, 14 and 15 concerning respective operations (without changing the output resistor Ro or without changing resistors which determine amplification factors of the amplifiers 13, 14 and 15). Consequently, only the gain of the gamma correction signal can be controlled by means of the current ratio without altering a ratio concerning the output resistance that may affect a correction point (inflection point) and a frequency characteristic.

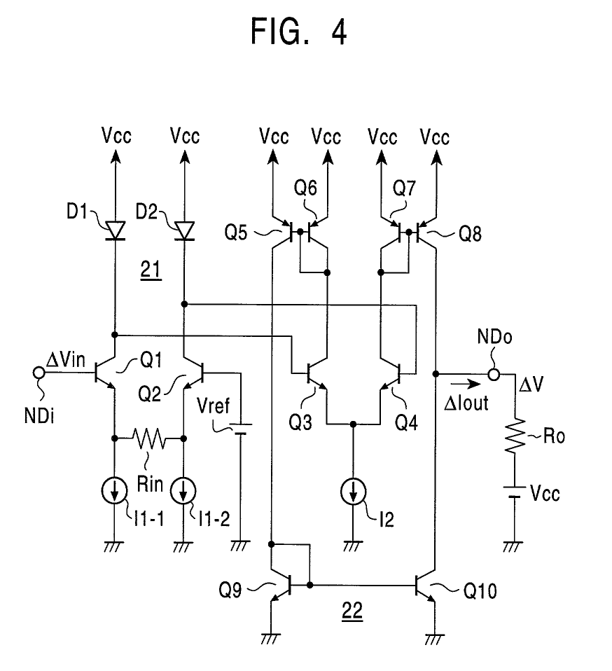

FIG. 4 is a circuit diagram showing an example of individual current differential amplifiers, each configures each of current differential amplifiers 13, 14 and 15 in the correction signal generating circuit 12 in the circuit shown in FIG. 3. That is, the configurations of the current differential amplifiers 13, 14 and 15 are the same.

The each of the current differential amplifier 13, 14 or 15 comprises a differential circuit 21 including transistors Q1 and Q2, a resistive element Rin, constant current sources I1-1 and I1-2 (current value of these constant current sources I1-1 and I1-2 is I1), diodes D1 and D2, a current source circuit 22 including input transistors Q3 and Q4, a constant current source I2 and transistors Q5 to Q10.

In the differential circuit 21, an emitter electrode of the transistor Q1 and an emitter electrode of the transistor Q2 are connected with each other through the resistive element Rin. The emitter electrode of the transistor Q1 is grounded through the constant current source I1-1. The emitter electrode of the transistor Q2 is grounded through the constant current source I1-2. A base electrode of the transistor Q1 becomes the input node NDi, and the input imaging signal Si (the same one of the signal supplied to the main signal processing circuit 11) is supplied. A base electrode of the transistor Q2 is connected with a reference-voltage power supply Vref for generating a reference voltage for the differential circuit 21.

A collector electrode of the transistor Q1 is connected with a cathode of the diode D1. An anode of the diode D1 is connected with a power source voltage Vcc. A collector electrode of the transistor Q2 is connected with a cathode of the diode D2. An anode of the diode D2 is connected with the power source voltage Vcc.

Moreover, the collector electrode of the transistor Q1 is connected with a base electrode of the input transistor Q3 of the current source circuit 22. The collector electrode of the transistor Q2 is connected with a base electrode of the input transistor Q4 of the current source circuit 22.

In the current source circuit 22, emitter electrodes of the transistors Q3 and Q4, each base electrode of which an output of the differential circuit 21 is supplied to, are grounded through the constant current source I2, respectively. The collector electrode of the transistor Q3 is connected with an input of a current mirror circuit composed of the pair transistors Q5 and Q6. That is, the collector electrode of the transistor Q3 is connected with a short-circuit point of a base electrode and a collector electrode of the transistor Q6 in the pair transistors Q5 and Q6 having a common base connection. A collector electrode of the transistor Q4 is connected with an input of a current mirror circuit composed of the pair transistors Q7 and Q8. That is, the collector electrode of the transistor Q4 is connected with a short-circuit point of a base electrode and a collector electrode of the transistor Q7 in the pair transistors Q7 and Q8 having a common base connection. Each emitter electrode of the transistors Q5 to Q8 is connected with the power source voltage Vcc.

A collector electrode of the transistor Q5 (the output terminal of the current mirror circuit composed of the pair transistors Q5 and Q6) is connected with a current mirror circuit composed of the pair transistors Q9 and Q10. That is, the collector electrode of the transistor Q5 is connected with a short-circuit point of a base electrode and a collector electrode of the transistor Q9 in the pair transistors Q9 and Q10 having a common base connection. Each emitter electrode of the pair transistors Q9 and Q10 is grounded.

A collector electrode of the transistor Q8 (the output terminal of the current mirror circuit composed of the pair transistors Q7 and Q8) is connected with a collector electrode of the transistor Q10 (the output terminal of the current mirror circuit composed of the pair transistors Q9 and Q10), and connected with an output node NDo. That is, the collector electrode of the transistor Q8 is connected with one end of the output resistor Ro (the output resistance in the gamma correction circuit) in the main signal processing circuit 11 shown in the previous FIG. 3. In FIG. 4, the output resistor Ro in the main signal processing circuit 11 is illustrated for the sake of convenience.

The operation of the current differential amplifier 21, 22 is shown in the following expressions by the use of reference characters in FIG. 4 as current values and resistance values. Supposing that a input imaging signal voltage at the input node NDi is ΔVin and an output current at the output node NDo is ΔIout, a conductance gm is expressed as follows.

gm=ΔIout/ΔVin={I2/I1}×{1/Rin} (1)

Supposing that an output voltage over the output resistor Ro is ΔV, the output voltage ΔV is expressed as follows.

ΔV={I2/I1}×{Ro/Rin}×ΔVin (2)

From the expression (2), it can be known that the gain of the current differential amplifier can be varied not only in conformity with a resistance ratio but also in conformity with a current ratio. That is, even if the output resistor Ro in the gamma correction circuit is used as a common output load in the main signal processing circuit 11 and in the correction signal generating circuit 12, the gamma correction signal can be adjusted (adding operation for the correction signals is done in accordance with a current flowing through the resistor Ro). That is, the correction amount of the gamma correction signal can be controlled by varying the ratio of the current value of the constant current source I1 and the constant current source I2 {I2/I1 } in each of the current differential amplifiers 13, 14 and 15.

Furthermore, an inflection point of a gamma correction curve in the gamma correction is determined on the basis of the input dynamic range of each of the current differential amplifiers 13, 14 and 15 (Rin/I1 in FIG. 4). Accordingly, only the gain can be controlled by varying the current value of the constant current source I2. Thereby, it becomes possible to control the gamma correction amount without affecting the correction point (inflection point) and the frequency characteristic.

According to the aforesaid embodiment, it becomes possible to control the gamma correction amount by configuring the correction signal generating circuit with the current differential amplifier (trans-conductance amplifier). Thereby, the degree of freedom is improved. For example, image quality is controlled in accordance with the taste of a user of the computer display apparatus, color matching between a computer display apparatus and various color printers are realized, and so on.

Incidentally, the control of the correction amount of the gamma correction signal by the correction signal generating circuit may be common in each channel of R, G and B, or may be performed separately for each channel. Moreover, a correction of brightness at a plurality of points can be controlled by increasing the number of the current differential amplifiers connected in parallel with each other in the correction signal generating circuit. Moreover, according to the present invention, the control of the gamma correction of the cathode ray tube having any kind of characteristic can easily be realized besides a computer display apparatus.

Although the invention has been described in its preferred form with a certain degree of particularity, obviously many changes and variations are possible therein. It is therefore to be understood that the present invention may be practiced than as specifically described herein without departing from scope and the sprit thereof.

What is claimed is:

1. A gamma correction circuit for correcting a luminous characteristic of a cathode ray tube, comprising:
a main signal processing circuit for receiving an input imaging signal and for generating an output signal in accordance with a reference voltage and an output resistance, and
a correction signal generating circuit for generating a correction signal to be added to said output signal from said main signal processing circuit in response to the input imaging signal supplied to said correction signal generating circuit, wherein
said correction signal generating circuit includes a plurality of current differential amplifiers connected in parallel to each other.

2. The gamma correction circuit according to claim 1, wherein
said output resistance functions to serve as a common output load to said main imaging signal processing circuit and said correction signal generating circuit.

3. The gamma correction circuit according to claim 1, wherein
said input imaging signal includes color RGB signals.

4. The gamma correction circuit according to claim 1, wherein
said main signal processing circuit includes a first transistor having a control terminal to which said input imaging signal is supplied, and a second transistor having a control terminal to which said reference voltage is supplied,
a first terminal of said first transistor and a first terminal of said second transistor are commonly connected to each other through a first resistive element and also connected to a first current source,
a second terminal of said second transistor is connected to a power source through a second resistive element, and
said second terminal of said second transistor is also connected to an output terminal of said current differential amplifier.

5. The gamma correction circuit according to claim 1, wherein
each of said current differential amplifiers includes a third transistor having a control terminal to which said input imaging signal is supplied, and a fourth transistor having a control terminal to which a second reference voltage is supplied,
a first terminal of said third transistor and a first terminal of said fourth transistor are commonly connected to each other through a third resistive element and also connected to the second current source,
second terminals of the third and the fourth transistors are respectively connected to control terminals of a differential amplifying circuit,
respective first terminals of said differential amplifying circuit are commonly connected to a third current source, and
respective first terminals of said differential amplifying circuit are connected to said output signal from said main imaging signal processing circuit through a current mirror circuit connected to one of second terminals of the differential amplifying circuit.

6. The gamma correction circuit according to claim 4, wherein
each of said current differential amplifiers includes a third transistor having a control terminal to which said input imaging signal is supplied, and a fourth transistor having a control terminal to which a second reference voltage is supplied,
a first terminal of said third transistor and a first terminal of said fourth transistor are commonly connected to each other through a third resistive element and also connected to the second current source,
second terminals of the third and the fourth transistors are respectively connected to control terminals of a differential amplifying circuit,
respective first terminals of said differential amplifying circuit are commonly connected to the third current source, and
respective first terminals of said differential amplifying circuit are connected to said output signal from said main signal processing circuit through a current mirror circuit connected to one of second terminals of the differential amplifying circuit.

7. The gamma correction circuit according to claim 5, wherein
a gamma corrected output imaging signal of said gamma correction circuit is controlled on a basis of a ratio of current values of said second current source and said third current source.

8. The gamma correction circuit according to claim 6, wherein
a gamma corrected output signal of said gamma correction circuit is controlled in response to a ratio of current values of said second current source and said third current source.

9. A display apparatus comprising:
a gamma correction circuit to which an input imaging signal is supplied;
an amplifier for amplifying a gamma corrected output imaging signal from said gamma correction circuit, and
an electron gun to which an output signal from said amplifier is supplied, wherein
said gamma correction circuit comprises:
a main signal processing circuit for receiving an input imaging signal and for generating an output signal in accordance with a reference voltage and an output resistance, and
a correction signal generating circuit for generating a correction signal to be added to said output signal from said main signal processing circuit in response to the input imaging signal supplied to said correction signal generating circuit, wherein
said correction signal generating circuit includes a plurality of current differential amplifiers connected in parallel to each other.

10. The display apparatus according to claim 9, wherein
said output resistance functions to serve as a common output load to said main signal processing circuit and said correction signal generating circuit.

11. The display apparatus according to claim 9, wherein
said input imaging signal includes color RGB signals.

12. The display apparatus according to claim 9, wherein
said main signal processing circuit includes a first transistor having a control terminal to which said input imaging signal is supplied, and a second transistor having a control terminal to which said reference voltage is supplied,
a first terminal of said first transistor and a first terminal of said second transistor are commonly connected to each other through a first resistive element and also connected to a first current source,
a second terminal of said second transistor is connected to a power source through a second resistive element, and
said second terminal of said second transistor is also connected to an output terminal of said correction signal generating circuit.

13. The display apparatus according to claim 9, wherein:
each of said current differential amplifiers includes a third transistor having a control terminal to which said input imaging signal is supplied, and a fourth transistor having a control terminal to which a second reference voltage is supplied,
a first terminal of said third transistor and a first terminal of said fourth transistor are commonly connected to each other through a third resistive element and also connected to a second current source,
second terminals of the third and the fourth transistors are respectively connected to control terminals of a differential amplifying circuit,
respective first terminals of said differential amplifying circuit are commonly connected to a third current source, and
respective first terminals of said differential amplifying circuit are connected to said output signal from said main signal processing circuit through a current mirror circuit connected to one of second terminals of the differential amplifying circuit.

14. The display apparatus according to claim 12, wherein:
each of said current differential amplifiers includes a third transistor having a control terminal to which said input imaging signal is supplied, and a fourth transistor having a control terminal to which a second reference voltage is supplied,
a first terminal of said third transistor and a first terminal of said fourth transistor are connected to each other through a third resistive element in common and also connected to a second current source,
second terminals of the third and the fourth transistors are respectively connected to control terminals of a differential amplifying circuit,
respective first terminals of said differential amplifying circuit are commonly connected to a third current source, and
respective first terminals of said differential amplifying circuit are connected to said output signal from said main signal processing circuit through a current mirror circuit connected to one of second terminals of the differential amplifying circuit.

15. The display apparatus according to claim 13, wherein
said gamma corrected output signal of said gamma correction circuit is controlled on a basis of a ratio of current values of said second current source and said third current source.

16. The display apparatus according to claim 14, wherein
said gamma corrected output signal of said gamma correction circuit is controlled on a basis of a ratio of current values of said second current source and said third current source.
